(19) United States
(12) Patent Application Publication
(10) Pub. No.: US 2002/0072045 A1
(43) Pub. Date: Jun. 13, 2002

(54) Vexing vanes: chemistry puzzle and teaching device

(76) Inventor: William Possidento, Park Ridge, NJ (US)

Correspondence Address: John P. Halvonik, 806 West Diamond Ave., Ste 301, Gaithersburg, MD, 20878, US

(21) Appl. No.: 09/734,878

(22) Filed: Dec. 13, 2000

(51) Int. Cl. G09B 23/26

(52) U.S. Cl. 434/282

(57) ABSTRACT

A puzzle apparatus for the study of chemistry and its history and based upon the Giguere model of the periodic table of the chemical elements. The puzzle includes a base and an optional spine holding a series of framework sections that are designed to hold a plurality of tiles. Each of the tiles corresponds to a single chemical element that belongs to a given electron sub-orbital grouping of elements according to the Giguere model of the periodic table. Each of the framework sections is arranged in a three dimensional space in relationship to the other sections and in keeping with the Giguere model of these relationships.

### FIELD AND BACKGROUND OF THE INVENTION

The invention relates to the field of teaching devices and, in particular, to a puzzle based upon the periodic table of the chemical elements which involves tile depictions of the various elements of the periodic table and a skeletal framework that represents the various orbital sections of the periodic table of elements as represented by Giguere, Three dimensional model of the elements.

The tiles depict the electronic configurations (viz. how many electrons and in which electronic orbitals that are thought to exist), among other information, of each element and are placed by the student into which the framework in order to successfully complete the puzzle along the lines indicated by the model. The Giguere model includes the notion of those elements corresponding to different electron shell orbitals being grouped together and the various groupings produced are then arranged in three dimensional space in relation to one another along a vertical spine.

In the present invention, the Giguere model is thus closely followed by the structure of the puzzle having a spine and a series of framework sections that are held in three dimensional relationship with one another upon this spine. The framework sections are sized and shaped to hold the various tiles representing the elements. The challenge for the student is to use the information on the tiles. (e.g. the orbital configuration) and use that to place the those elements (really the tiles) into the correct framework sections and in the correct relationship with the other elements in that section.

### PRIOR ART

While there are three dimensional puzzles that are known in the prior art, none of them are based upon a skeletal framework and tiles that represent a periodic chart of the chemical elements. Nor are there known any chemistry puzzles that are based upon the Giguere three dimensional model of the periodic table. Nor for that matter, are there any known chemical puzzles based upon completing a puzzle so that it conforms to a periodic representation of the elements.

### SUMMARY OF THE INVENTION

A learning puzzle for the study of chemistry and based upon the Giguere model of the periodic table of the chemical elements. The puzzle includes a base and an optional spine that is in connection with a series of framework sections that are designed to hold a plurality of tiles that each correspond to a single element that belongs in the periodic chart. Each of the framework sections corresponds to a given orbital shell of the periodic table and thus will hold a number of tiles corresponding to the number of elements that are said to correspond to that orbital when the periodic chart is completed.

These sections are arranged upon the spine in a three dimensional relationship to one another. Space in each section allows for the placement of the tiles to form in the familiar matrices that represent an arrangement of elements that corresponds to a particular orbital shell.

The challenge for the student is to place the elements of the periodic table as depicted on the tiles into the correct framework sections corresponding to the proper electron orbital shells that correspond to those elements and to maintain the proper relationship among those elements in any particular orbital shell. I.e. the student must not only place the tiles in the correct orbital shell that they belong to but also place each element/tile in the correct relationship to the other elements/tiles in that section.

It is an object of the invention to provide a learning puzzle that is enjoyable to do and encourages students to recall and to understand those spatial and chemical relationships of the elements as depicted in the Giguere model of the periodic table.

Another object of the invention to provide a learning puzzle for allowing students to construct a periodic table along the lines of the Giguere model and to develop an understanding of the relationship of the various orbital shells and the elements that fill them with respect to the other orbital shells that are said to make up the periodic table.

Another object of the invention to provide a learning puzzle to provide students with an empty three dimensional representation of the periodic elements and allow them to fill up the empty version with tiles corresponding to the various elements that make up the table.

Another object is to provide a challenging puzzle that can teach students the relationships of the various elements vis a vis one another and based upon the electron shell configurations of such elements.

Another object is to provide a puzzle to study the Giguere three dimensional model of the periodic table and to construct this puzzle using the same dimensional relationships as hypothesized by that model.

Other advantages will be seen by those skilled in the art once the invention is shown and described.

### DESCRIPTION OF DRAWINGS

FIG. 1 Giguere's model that arranges the periodic elements into a three dimensional table having four vanes;

FIG. 2 puzzle apparatus based upon Giguere's model;

FIG. 3 detail of two element tiles that are to be placed in the f block.

### DESCRIPTION OF THE PREFERRED EMBODIMENT

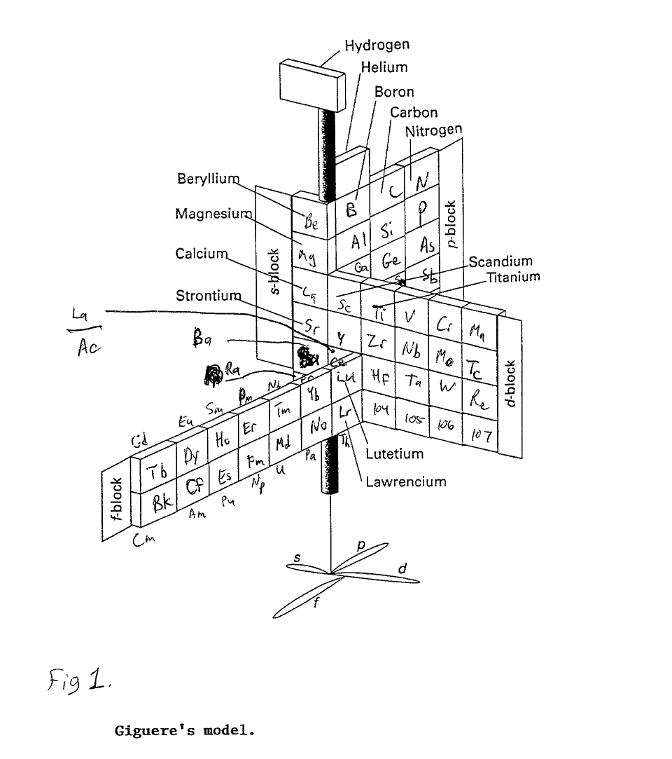

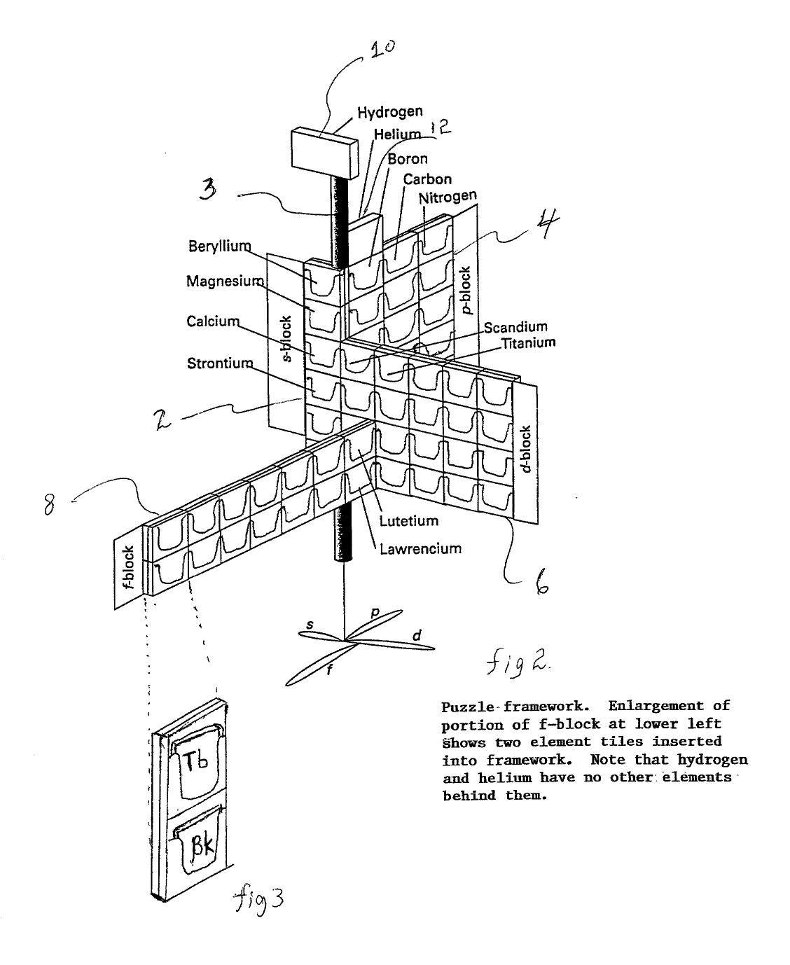

The overall skeletal framework that forms the basis for the construction of the tiles is shown in FIG. 2. This framework is based upon the Giguere Model of the chemical elements and this models involves the use and visualization of the elements in a three dimensional world based upon a vertical axis. Each section of the Model is based upon one of the orbital shells of the elements and thus each section can hold a number of tiles corresponding to the elements. See FIG. 1.

By necessity, then the various framework sections of the puzzle correspond to these orbitals and therefore must hold the prerequisite number of tiles corresponding to that number of elements that are in that particular orbital shell. For example the d-shell orbital of the periodic table is said to contain 40 elements, staring with Scandium and Titanium (see no. 6 in FIG. 1)

Note: That in the case of shell orbitals, the number of elements and their members corresponds not just to the Giguere model, but rather to most recognized periodic tables)

Those 40 elements that fill this section of the puzzle are those 40 that most chemical models describe as having filled their d shell electron orbital in order to complete the final electron configuration for that element. Thus the framework section corresponding to the so called d shell elements will hold those 40 elements associated with filling the d shell in the periodic chart.

The same description holds true for the other electron shells depicted in this model including the so called: s (2 in FIG. 2), p (4 in FIG. 2) and f (8 in FIG. 2) electron shells. Still other shells may be included as they may become known and/or hypothesized in the literature.

Each of the tiles should have on it, as a minimum, the atomic sybmol of that element, such as He for the element, Helium. See FIG. 3 showing the tiles for Tb and Bk.

In addition, it is thought useful to have the atomic number and the electron configuration information about that element as well. This information can and should be used by the student to learn how to fit the tiles into the puzzle framework. Eventually, the student may be facile enough to simply put the pieces into the framework based upon the name or the atomic number alone; however the puzzle is a learning experience and may include the electron configuration information for the sake of making the model complete.

Preferably each tile will also contain the name of the element corresponding to that atomic number and likely other information as well, including: atomic weight, other properties associated with the element and so forth. The various frame sections of the model may also be designated as “p-shell suborbital” and so forth in order to further explain this model and to enhance the role of the puzzle as an elegant tool in the learning experience.

In the Giguere model, hydrogen is thought of as being its own shell configuration and in his model was depicted as being at the top the various shell representations (see 10 in FIG. 2). Thus, it may be desirable that the framework corresponding to Hydrogen be giving a separate frame at the top of the spine as can be seen in FIGS. 1 and 2.

Helium has been hypothesized as standing alone in the Giguere model and so its framework section (see 12 in FIG. 2) can hold only one tile and is best placed in connection with the p-shell frame section (4 in FIG. 2), at the top of that section, see FIG. 1.

In fact, the literature is not conclusive on the issue of where Helium shoud be placed in the model, some models have hydrogen and helium at the top of the s block, whereas others have only hydrogen above the s block with helium above neon on top of the p block. Thus, the invention can be constructed with both H and He at the top of the model, with both elements placed in the position of 10 in FIG. 2 (which position holds only H in that version) or with He above the s-block and above the element neon or, alternately; as it is shown in FIG. 2.

The spine 3 and supporting framework may be comprised of for example: wire or perhaps a relatively transparent material such as plastic or glass. Such framework should allow the tiles of the elements to be viewed on both sides when they are fitted into a complete puzzle. The tiles may be made of various materials including wood, plastic, light metals such as aluminum and other materials that may be applicable given the nature of the invention. See FIG. 3.

I claim:

1. A teaching puzzle apparatus based upon the Giguere representation of chemical elements that visualizes those elements from the periodic table as fitting into various electron shell configurations in a matrix array; said apparatus having a vertical spine supported upon a base so that said spine is oriented in a vertical direction, said spine having a series of framework sections, each of said framework sections adapted for supporting a plurality of said tiles arranged within said sections, a plurality of atomic tiles, each of said atomic tiles corresponding to a chemical element in the Giguere representation; said framework sections corresponding to electronic sub orbitals based upon Giguere representation and capable of holding said atomic tiles in an n by m matrix array, where n corresponds to the number of rows of the periodic chart for said chemical elements that comprise a given orbital shell and m comprises the number of members in each row of the periodic chart for said chemical elements that are members of a given orbital shell; wherein each of said atomic tiles contains a representation of the elemental symbol corresponding to said chemical element that corresponds to said tile.

2. The apparatus of claim 1 wherein each of said tiles contains information pertaining to the atomic number of said chemical element that corresponds to said tile.

3. The apparatus of claim 2 wherein each of said tiles further contains information pertaining to the electron configuration of said chemical element that corresponds to said tile.

4. The apparatus of claim 3 wherein each of said tiles further contains information pertaining to the atomic properties of said elements.
